(19) United States
(12) Patent Application Publication
(10) Pub. No.: US 2007/0057169 A1
(43) Pub. Date: Mar. 15, 2007

(54) Package structure for an optical sensor

(76) Inventors: Chung-Chi Hsiao, Shin-Chu (TW); Po-Hung Chen, Shin-Chu (TW); Mao-Jung Chen, Shin-Chu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/225,076

(22) Filed: Sep. 14, 2005

(51) Int. Cl. H01J 40/14

(52) U.S. Cl. 250/239

(57) ABSTRACT

The present invention relates to a package structure for an optical sensor having a base set with the plurality of metallization traces on its upper and under surface and several conductors passing through the base electrically connects to the plurality of metallization traces on the surface; at least one optical sensor and its peripheral frame are set upon the base in which the conductors can be located within the frame area or the area between the optical sensor and the frame; and a light-pervious lid encapsulates the frame and completes the package structure. In addition, an enclosing base having a containing capacity can be adopted to replace the base and the frame. The present invention can efficiently raise the reliability of elements and yield and quality by said package structure.

### BACKGROUND OF THE INVENTION

1. Field of the Invention

The present invention relates to a package structure of semiconductor elements, more particularly, to a package structure for an optical sensor being able to raise the reliability of elements and yield.

2. Description of related art

Please refer to FIG. 1, which shows a common package structure of a CMOS optical sensor. The package structure has a base 10 with the plurality of metallization traces 12 formed on it which laterally extends to the under surface and serves as a contact; a frame 16 is adhered to the surface of the base 10 by using a first adhesive layer 14 and an optical sensor chip 18 having a optical sensing area 20 is set on the base 10 by application of an adhesive glue 28; the optical sensor chip 18 electrically connects to the plurality of metallization traces 12 of the base 10 by the connection of metallic wire 22 between the optical sensor 18 and the base 10; a second adhesive layer 24 is applied to adhere a light pervious glass 26 onto the frame 16 for encapsulating the optical sensor chip 18. The package is to isolate exterior contaminants and enables the CMOS optical sensor to sense the exterior environment truly.

However, there are still many problems in the package structure aforementioned. The main defect is that when reliability test is conducted, exterior mist would permeate into the optical sensor 18 through the first adhesive layer 14 due to the restricted adhesion between the frame 16 and the base 10 caused by the existence of the plurality of metallization traces 12 and causes quality problems. Besides, during the cleansing process of the packaging procedure, residue glue of the first adhesive layer 14 would contaminate the surface of the optical sensor chip 18 and result in impurities difficult to remove and lowers down the yield. Furthermore, because the electrical connection of the plated metallic layer of known package structure is achieved by the plurality of metallization traces 12 of the upper and under surface through the aperture around the edge, the aperture structure makes the first adhesive layer 14 leak from it when forming the adhesion between the frame 16 and the base 10 and results in a serious glue contamination on the package structure.

Accordingly, the present invention proposes a package structure for an optical sensor overcoming the drawbacks of the known art.

### SUMMARY OF THE INVENTION

The primary object of the present invention is to provide a package structure for an optical sensor with improved yield and quality by overcoming the problem of impurities like residue glue generated during the manufacturing process.

Another object of the present invention is to provide a package structure for an optical sensor which is capable of raising the reliability of the package structure and avoiding the problem of permeation of mist into the optical sensor when the reliability test is conducted.

According to the above-mentioned objects, the present invention provides a package structure for an optical sensor comprising a base set with the plurality of metallization traces on its upper and under surface and several conductors passing through the base electrically connects to the plurality of metallization traces of the surface, at least one optical sensor set on the base which electrically connects to the plurality of metallization traces, a frame formed upon the base and around the optical sensor enabling those conductors to be located within the frame area or the area between the optical sensor and the frame, and a light-pervious lid covers the frame for encapsulating the optical sensor.

Besides, aforementioned base and frame could also be a form-in-place enclosing base which the plurality of metallization traces thereof achieves electrical connection by conductors. The enclosing room of the enclosing base is set with at least one optical sensor electrically connecting to the plurality of metallization traces and a light-pervious lid is set on the enclosing base.

These and other objects, features, advantages and the efficacy of the present invention will become more apparent from the following description taken in connection with the accompanying drawings in which preferred embodiment of the present invention are show by way of illustrative example.

### BRIEF DESCRIPTION OF THE DRAWINGS

FIG. 1 is a cross-sectional view of a conventional package structure for an optical sensor.

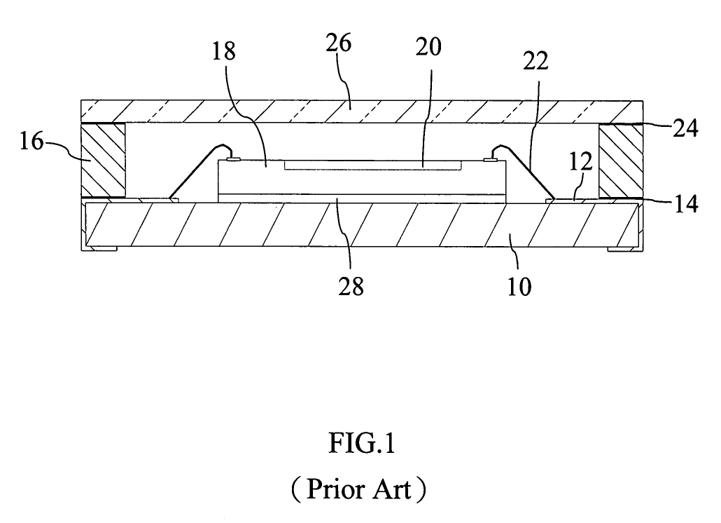

FIG. 2 is a cross-sectional view of a package structure for an optical sensor according to the present invention.

FIG. 3 is a cross-sectional view of one embodiment of a package structure for an optical sensor according to the present invention.

FIG. 4 is a cross-sectional view of another embodiment of a package structure for an optical sensor according to the present invention.

### DETAILED DESCRIPTION OF THE PREFERRED EMBODIMENT

The present invention provides a package structure of an optical sensor with higher reliability which efficiently avoids serious impurities on the surface of optical sensor caused by glue during the manufacturing process and therefore raises the yield.

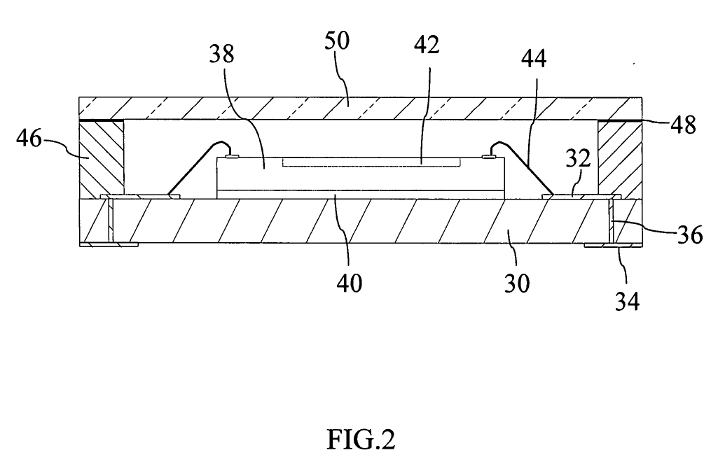

FIG. 2 shows the package structure of the present invention. The package structure for an optical sensor comprises a base 30 which can be printed circuit board, ceramic base, or molding base. An upper metallization 32 and the under plurality of metallization traces 34 are set on the upper and under surface of the base respectively and several conductors 36, usually plated through via holes, pass through the base and electrically connect the upper plurality of metallization traces 32 and the under plurality of metallization traces 34. An optical sensor 38, which is adhered on the base 30 through a first adhesive layer 40 which could be silver paste or adhesive tape, has an optical sensing area. The electrical connection between the optical sensor 38 and the base 30 is through a connection of metallic wire. A frame 46, which could be a molding frame, is formed on the base 30 and around the optical sensor 38. A second adhesive layer 48 is then applied to cover a light-pervious lid 50 on the frame 46 and encapsulates the optical sensor 38.

Because said package structure uses plated through via holes 36 to connect the upper plurality of metallization traces 32 and the under plurality of metallization traces 34 of the upper and under surface of the base 30 and the plated through via holes 36 are in the base 30 under the frame 46, the frame 46 and the base 30 can be combined tightly without being affected by the plurality of metallization traces 32.

To improve the adhesion between the base 30 and the frame 46, a convex (not shown in the figure) can be set on the base 30 and a concave (not shown in the figure) can be set on the relative position of the frame 46 to tightly combine the base 30 and the frame 46 by the conjunction of the convex and concave. Alternatively, a concave can be set on the base 30 and a convex can be set on the relative position on of the frame 46 to make the base 30 and the frame 46 combine tightly. In addition, a metallic layer (not shown in the figure) can be set between the base 30 and the optical sensor 38 to increase the convenience of combination and the heat dissipation. Moreover, the light-pervious lid can further have the property of filtering certain wavelengths of light like infrared ray.

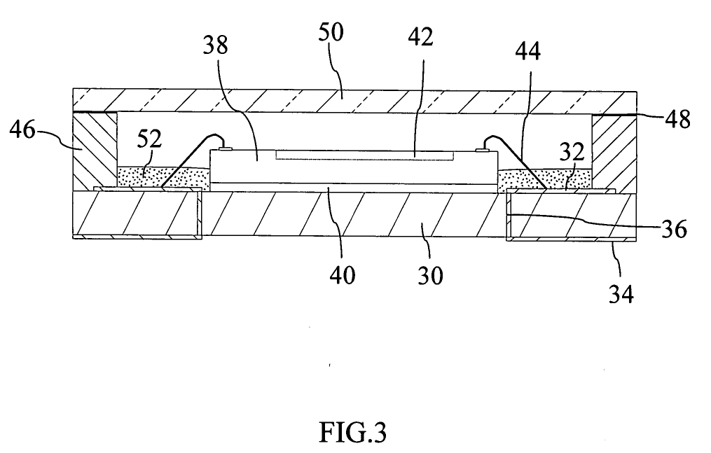

Besides being set in the frame area 46, the conductors 36 can also be located in other places. As shown in FIG. 3, the upper plurality of metallization traces 32 and the under plurality of metallization traces 34 are set on the upper and under surface of the base respectively and connect by the conductors 36 of plated-through via holes which are in the area between the frame 46 and the optical sensor 38. After finishing the electrical connection through wiring, a protective adhesive layer 52 will be coated between the frame 46 and the optical sensor 38 and then cured for sealing the apertures caused by the conductors 36 and preventing the permeation of mist from the bottom of the base 30 through the apertures. The adhesive layer 52 can be solder mask, UV glue or heat-cured adhesive. The rest of the structure is the same as shown in FIG. 2 and therefore won't be described again here.

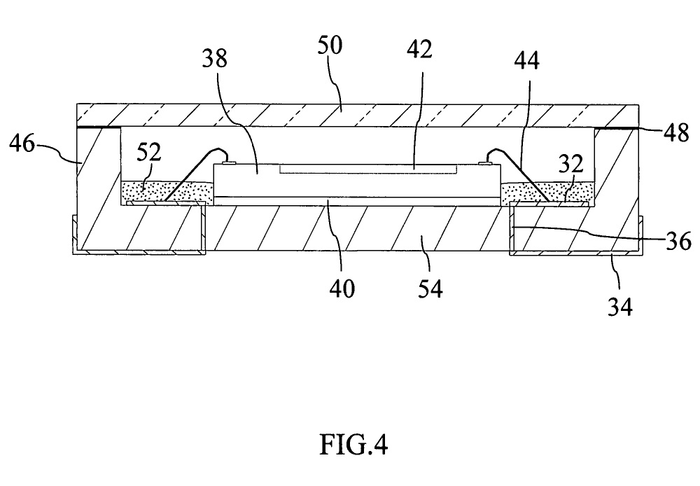

While above-mentioned embodiments all adhere the frame 46 on the base 30, the present invention can also adopt a form-in-place base and frame. Please refer to FIG. 4 which is the package structure for an optical sensor comprising a form-in-place enclosing base 54 which already has a frame to form a containing capacity. The enclosing base 54 can be a form-in-place ceramic base or molding base. The upper plurality of metallization traces 32 and the under plurality of metallization traces 34 are set on the upper and under surface of the form-in-place 54 respectively and several conductors 36 passing through the enclosing base are used to connect them. A optical sensor 38 is set in the containing capacity of the enclosing base 54 through a first adhesive layer 40 and electrically connects to the plurality of metallization traces 32. A second adhesive layer 48 is used to cover the frame of the enclosing base 54 with a light-pervious lid 50 and surely the under plurality of metallization traces 34 can extend to the external part of the enclosing base 54.

By adopting said package structure, one can avoid the impurities like residue glue caused during the manufacturing process and improve the yield and quality thereof efficiently. The present invention can further increase the reliability of package structure and avoid the problem caused by the permeation of mist into the optical sensor through the first adhesive layer.

While the present invention has been described with reference to the illustrative embodiment, this description is not intended to be construed in a limited sense. Various modifications of the illustrative embodiment of the invention will be apparent to those skilled in the art and fall within the scope of the invention.

What is claimed is:

1. A package structure for an optical sensor, comprising:
a base set with the plurality of metallization traces on its upper and under surface and electrically connects to the upper and the under plurality of metallization traces by several conductors passing through the base;
at least one optical sensor having an optical sensing area set on the base and electrically connects to the plurality of metallization traces;
a frame formed on the base and around the optical sensor making the conductors locate in the base under the frame or between the frame and the optical sensor; and
a light-pervious lid covering the frame.

2. The package structure for an optical sensor of claim 1, wherein the base can be printed circuit board or molding base.

3. The package structure for an optical sensor of claim 2, wherein the frame and the ceramic base or molding base are form-in-place.

4. The package structure for an optical sensor of claim 1, wherein the base has a convex and the frame has a concave at a relative position enabling the tight combination of the base and the frame.

5. The package structure for an optical sensor of claim 1, wherein the base has a concave and the frame has a convex at a relative position enabling the tight combination of the base and the frame.

6. The package structure for an optical sensor of claim 1, wherein the conductors are plated-through via holes.

7. The package structure for an optical sensor of claim 1, further comprising an adhesive layer adheres the optical sensor to the base, said adhesive layer could be silver paste or adhesive tape.

8. The package structure for an optical sensor of claim 1, further comprising a metallic layer between the base and the optical sensor.

9. The package structure for an optical sensor of claim 1, further comprising a protective adhesive layer covers on the upper or under surface of the base for sealing the apertures caused by the conductors and the adhesive layer can be solder mask, UV glue or heat-cured adhesive.

10. The package structure for an optical sensor of claim 1, wherein the light-pervious lid can filter certain light wavelengths such as infrared ray.

11. A package structure for an optical sensor, comprising:
an enclosing base having a frame for forming a containing capacity and the enclosing base is set with the plurality of metallization traces on its upper and under surface and electrically connects to the upper and the under plurality of metallization traces by several conductors passing through the base;
at least one optical sensor having an optical sensing area set on the base in the containing capacity and electrically connects to the plurality of metallization traces; and
a light-pervious lid covering on the frame of the enclosing base.

12. The package structure for an optical sensor of claim 1 1, wherein the conductors are plated-through via holes.

13. The package structure for an optical sensor of claim 11, wherein the plurality of metallization traces can further extend to the external part of the enclosing base.

14. The package structure for an optical sensor of claim 11, further comprising an adhesive layer adheres the optical sensor to the enclosing base, said adhesive layer could be silver paste or adhesive tape.

15. The package structure for an optical sensor of claim 11, further comprising a metallic layer between the base and the optical sensor.

16. The package structure for an optical sensor of claim 11, further comprising a protective adhesive layer covers on the upper or under surface of the base for sealing the apertures caused by the conductors and the adhesive layer can be solder mask, UV glue or heat-cured adhesive.

17. The package structure for an optical sensor of claim 1 1, wherein the light-pervious lid can filter certain light wavelengths such as infrared ray.

18. A package structure for an optical sensor, comprising:
a base set with the plurality of metallization traces on its upper and under surface and electrically connects to the upper and the under plurality of metallization traces by several conductors passing through the base;
at least one optical sensor having an optical sensing area set on the base and electrically connects to the plurality of metallization traces;
a frame formed on the base and around the optical sensor;
a light-pervious lid set on the frame; and
at least one protective adhesive layer set on the surface of the base for sealing the apertures caused by the conductors.

19. The package structure for an optical sensor of claim 18, wherein the protective adhesive layer could be solder mask, UV glue or heat-cured adhesive.
